(19) United States
(12) Patent Application Publication
(10) Pub. No.: US 2009/0033438 A1
(43) Pub. Date: Feb. 5, 2009

(54) Adjustable Phase Shifter For Antenna

(75) Inventors: Dau-Chyrh Chang, Taipei (TW); Bing-Hao Zeng, Dali City (TW); Ji-Chyun Liu, Dasi Township (TW)

Correspondence Address: APEX JURIS, PLLC, 12360 LAKE CITY WAY NORTHEAST, SUITE 410, SEATTLE, WA, 98125, US

(73) Assignee: SmartAnt Telecom Co., Ltd., Jhudong Township (TW)

(21) Appl. No.: 11/833,195

(22) Filed: Aug. 2, 2007

(51) Int. Cl. H01P 1/18

(52) U.S. Cl. 333/161

(57) ABSTRACT

An adjustable phase shifter for an antenna includes a metal circuit portion, a coupling portion, and a grounding portion. The metal circuit portion is used for receiving a fed-in signal, while the coupling portion is disposed on one side of the metal circuit portion and is disposed at an angle with respect to the metal circuit portion, for controlling a phase angle of the fed-in signal by adjusting the angle formed therebetween. The grounding portion is disposed on the other side of the metal circuit portion in parallel. The structure of the adjustable phase shifter for adjusting the phase angle output by the phase shifter is simple, so as to improving the fabrication efficiency. Moreover, the fabrication efficiency of the adjustable phase shifter is able to be further improved by adopting an attachable impedance matcher, or changing the structure of the coupling portion.

### BACKGROUND OF THE INVENTION

1. Field of Invention

The present invention relates to a phase shifter for an antenna, and more particularly to an adjustable phase shifter for an antenna.

2. Related Art

With the development of wireless communication technology, many products and techniques using multi-frequency transmission have been developed. Therefore, many electronic devices have the function of wireless communications to meet the requirements of consumers. Antennae are important elements in a wireless communication system for transmitting and receiving the energy of electromagnetic waves, and common antennae include dipole antennae, helical antennae, and the like.

In order to enable radio signals to be transmitted and received in different directions, a phase shifter is used to change phases of radio signals. Conventionally, the phase shifter is often a component made of a metal material, which has a low efficiency in signal coupling. Moreover, as the signals are transmitted in a contact manner, noise is generated at the mean time of changing the phase shift. In addition, conventional phase shifters have a large size, and cannot meet the design trend of “light, thin, small, and short”. Another problem is that conventional phase shifters are fabricated by metal mechanical structures, so more processes are required to fabricate the phase shifters.

US Patent Publication No. US20020003458 has disclosed a phase-shiftable network for an antenna array, which is integrated in a PCB distribution network including a PCB distribution element. The PCB distribution element includes a dielectric circuit board having transmission lines. The dielectric circuit board having the transmission line forms a transmission line network which includes a signal input end, three transmission paths, and three signal output ends, so as to feed input signals back to a top, a bottom, and a center of the array antenna. The PCB distribution element is supported on a ground plane. A movable dielectric element having sawtooth structures along opposite edges slides mounted over a top surface of the PCB distribution element. The movable dielectric element is supported in a slidable manner by two rods attached to the ground plane. By moving the movable dielectric element, the phases in the top and bottom sections of the antenna array are changed in opposite directions, such that the phase shift in one section is increased and the other section is decreased, which causes the radiating beam to tilt.

The above method for fabricating the phase shifter has been greatly simplified, and the structure and size of the fabricated phase shifter are reduced compared with conventional ones. However, the actuation mechanism of the movable dielectric element still has room for improvement in terms of the convenience in the fabricating processes.

### SUMMARY OF THE INVENTION

Accordingly, the object of the present invention is to provide an adjustable phase shifter for an antenna, which has simple structure to improve the fabrication efficiency to fabricate the phase shifter. The fabrication efficiency of the adjustable phase shifter is able to be further improved by adopting an attachable impedance matcher, or changing the structure of the coupling portion.

To achieve aforementioned object, an adjustable phase shifter for an antenna of the present invention is provided, which includes a metal circuit portion, a coupling portion, and a grounding portion. The metal circuit portion is used for receiving a fed-in signal. The coupling portion is disposed on one side of the metal circuit portion for matching an impedance of the metal circuit portion, and is disposed at an angle with respect to the metal circuit portion, for controlling a phase angle of the fed-in signal by adjusting the angle formed therebetween. The grounding portion is disposed on the other side of the metal circuit portion in parallel.

The adjustable phase shifter for an antenna adjusts the angle formed between a metal circuit portion and the coupling portion to make the coupling amounts at different output ends of the a metal circuit portion to be different, so as to strengthen the control over the change of the phase angle of each output end of the phase shifter. Moreover, the fabrication efficiency of the adjustable phase shifter is able to be further improved by adopting an attachable impedance matcher, or changing the structure of the coupling portion.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a perspective view of a first embodiment of the present invention;

FIG. 1B is a perspective view of a second embodiment of the present invention;

FIG. 1C is a perspective view of a third embodiment of the present invention;

FIG. 1D is a perspective view of a fourth embodiment of the present invention;

FIG. 2A is a exploded view of a fifth embodiment of the present invention;

FIG. 2B is a perspective view of the fifth embodiment of the present invention;

FIG. 3A is a cross-sectional view of the fifth embodiment of the present invention; and

FIG. 3B is a cross-sectional view of the fifth embodiment of the present invention.

### DETAILED DESCRIPTION OF THE INVENTION

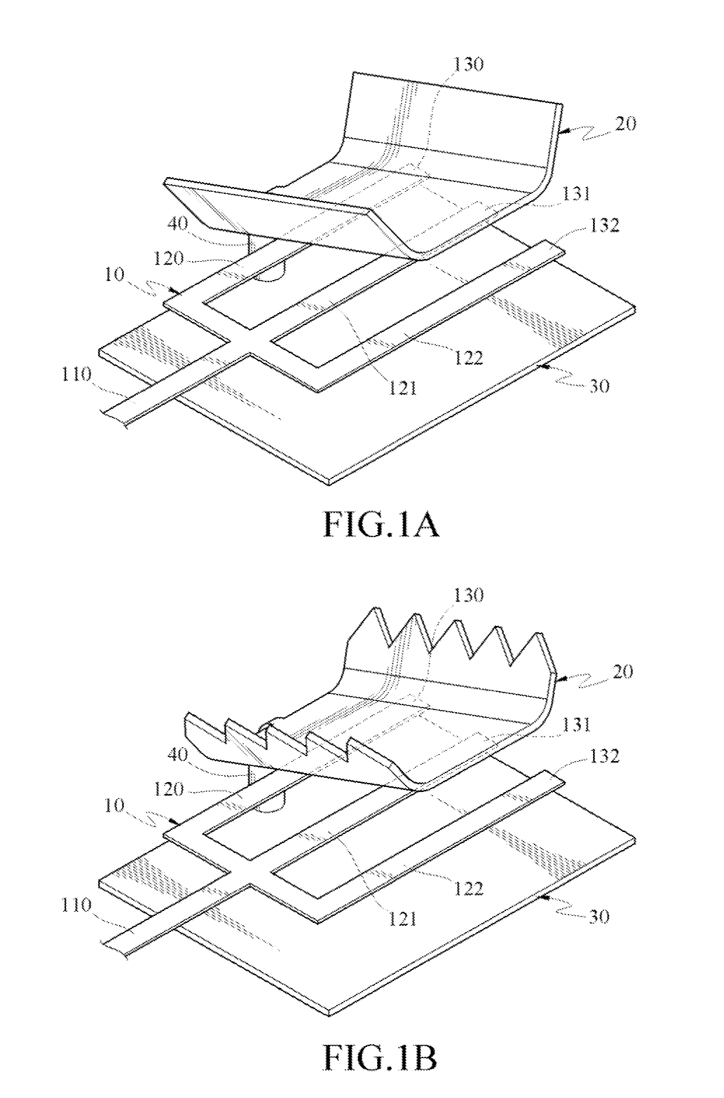

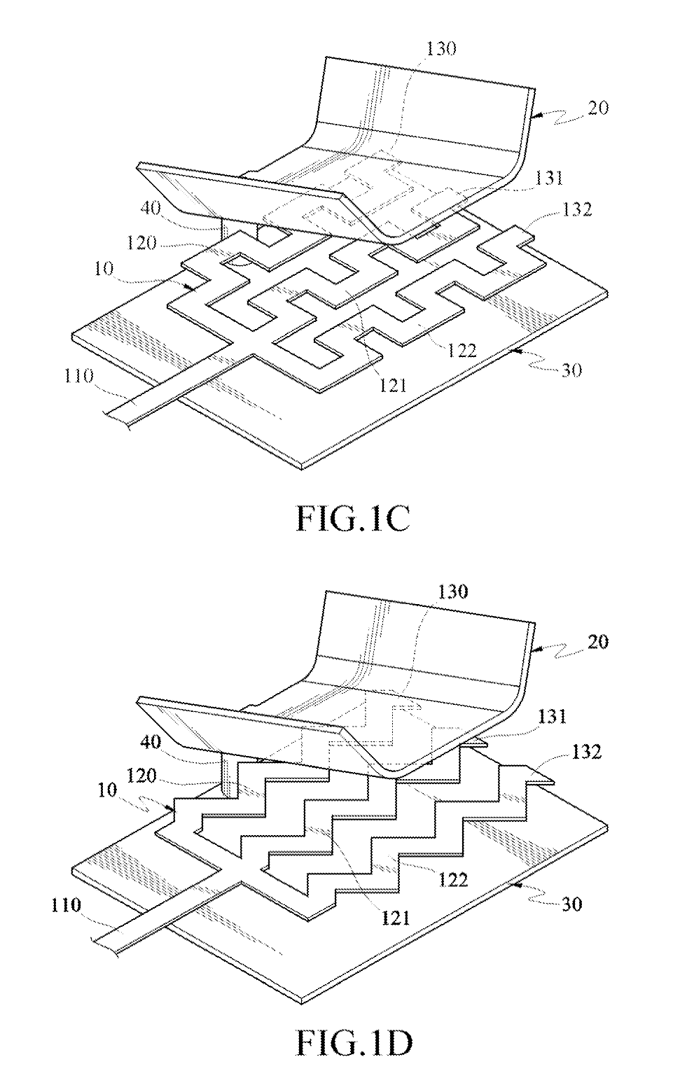

Referring to FIG. 1A, an adjustable phase shifter for an antenna of a first embodiment of the present invention is shown, which includes a metal circuit portion 10, a coupling portion 20, a grounding portion 30, and an adjusting portion 40.

The metal circuit portion 10 is used for receiving a fed-in signal, and has a signal input end 110, a first signal transmission line 120, a second signal transmission line 121, a third signal transmission line 122, a first signal output end 130, a second signal output end 131, and a third signal output end 132. The signal input end 110 is used for receiving the fed-in signal, and generates fed-in signals of different phases through the first signal transmission line 120, the second signal transmission line 121, and the third signal transmission line 122 respectively. Then, the fed-in signals of different phases are output from the first signal output end 130, the second signal output end 131, and the third signal output end 132 respectively. The first signal transmission line 120, the second signal transmission line 121, and the third signal transmission line 122 are all straight lines, and arranged in parallel to one another.

Moreover, the first signal transmission line 120, the second signal transmission line 121, and the third signal transmission line 122 can also be designed into serpentine lines (a third embodiment as shown in FIG. 1C) or zigzag lines (a fourth embodiment as shown in FIG. 1D), so as to meet the design requirements of impedance. The difference between the phase angles can be designed by changing the number of the signal transmission lines. For example, if three signal transmission lines are used, the phase difference of each line is 120 degrees. If four signal transmission lines are used, the phase difference of each line is 90 degrees. Other situations can be deduced in the similar way.

The coupling portion 20 is disposed on one side of the metal circuit portion 10, the metal circuit portion 10 is located between the coupling portion 20 and the grounding portion 30. The cross-section area of the coupling portion 20 is U-shaped. Two tilted sides of the coupling portion 20 are in symmetry. The coupling portion 20 is disposed at an angle with respect to the metal circuit portion 10 for controlling the phase angles of the fed-in signals output from the first signal output end 130, the second signal output end 131, and the third signal output end 132 of the metal circuit portion 10 by adjusting the angle formed between the coupling portion 20 and the metal portion 10. The coupling portion 20 is made of a dielectric material, such as a resin material, a plastic material, an organic glass fiber substrate (FR4), or a ceramic material.

In addition, the vertical height distance between the body of the coupling portion 20 and each signal transmission line on the metal circuit portion 10 is different according to the angle formed between the coupling portion 20 and the metal circuit portion 10, which further makes the signal coupling amount on each signal transmission line to be different, thereby strengthening the control over the change of the phase angle of each output end of the phase shifter.

The grounding portion 30 is disposed on the other side of the metal circuit portion 10 in parallel, and is spaced at a predetermined distance from the metal circuit portion 10 without being electrically connected. The grounding portion 30 is made of metal, and has an area slightly larger than those of the metal circuit portion 10 and the coupling portion 20. The grounding portion 30 is used as a grounding loop of the adjustable phase shifter.

The adjusting portion 40 is connected with the coupling portion 20, and is disposed on the grounding portion 30. The adjusting portion 40 has a structure that rotates to drive the coupling portion 20 (e.g., a pivot seat), thereby adjusting the angle formed between the coupling portion 20 and the metal circuit portion 10. The adjusting portion 40 can also be disposed on the case of the adjustable phase shifter, the metal circuit portion 10, or other objects capable of providing a fixed point of support. The adjusting portion 40 can also use other displacement technical means to achieve the pivot structure capable of adjusting the angle formed between the coupling portion 20 and the metal circuit portion 10, e.g., a pivot structure with two rotation axes (X axis and Y axis).

Referring to FIG. 1B, an adjustable phase shifter for an antenna of a second embodiment of the present invention is shown, which includes a metal circuit portion 10, a coupling portion 20, a grounding portion 30, and an adjusting portion 40.

The metal circuit portion 10 is used for receiving a fed-in signal, and has a signal input end 110, a first signal transmission line 120, a second signal transmission line 121, a third signal transmission line 122, a first signal output end 130, a second signal output end 131, and a third signal output end 132. The signal input end 110 receives the fed-in signal, and generates fed-in signals of different phases through the first signal transmission line 120, the second signal transmission line 121, and the third signal transmission line 122 respectively. Then, the fed-in signals of different phases are output from the first signal output end 130, the second signal output end 131, and the third signal output end 132 respectively. The first signal transmission line 120, the second signal transmission line 121, and the third signal transmission line 122 are all straight lines, and arranged in parallel to one another.

Moreover, the first signal transmission line 120, the second signal transmission line 121, and the third signal transmission line 122 can also be designed to be serpentine lines (the third embodiment as shown in FIG. 1C) or zigzag lines (the fourth embodiment as shown in FIG. 1D), so as to meet the design requirements of impedance. The difference between the phase angles can be designed by changing the number of the signal transmission lines. For example, if three signal transmission lines are used, the phase difference of each line is 120 degrees. If four signal transmission lines are used, the phase difference of each line is 90 degrees. Other situations can be deduced in the similar way.

The coupling portion 20 is disposed on one side of the metal circuit portion 10, and the metal circuit portion 10 is located between the coupling portion 20 and the grounding portion 30. The cross-section area of the coupling portion 20 is U-shaped. Two sides in parallel of the coupling portion 20 are jagged structures, and the two tilted sides are in symmetry. The coupling portion 20 is disposed at an angle with respect to the metal circuit portion 10 for controlling the phase angles of the fed-in signals output from the first signal output end 130, the second signal output end 131, and the third signal output end 132 of the metal circuit portion 10 by adjusting the angle formed between the coupling portion 20 and the metal portion 10. The coupling portion 20 is made of a dielectric material, such as a resin material, a plastic material, an organic glass fiber substrate (FR4), or a ceramic material.

In addition, the vertical height distance between the body of the coupling portion 20 and each signal transmission line on the metal circuit portion 10 is different according to the angle formed between the coupling portion 20 and the metal circuit portion 10, which makes the signal coupling amount on each signal transmission line to be different, thereby strengthening the control over the change of the phase angle of each output end of the phase shifter.

The grounding portion 30 is disposed on the other side of the metal circuit portion 10 in parallel, and is spaced at a predetermined distance from the metal circuit portion 10 without being electrically connected. The grounding portion 30 is made of a metal material, and has an area slightly larger than those of the metal circuit portion 10 and the coupling portion 20. The grounding portion 30 is used as a grounding loop of the adjustable phase shifter.

The adjusting portion 40 is connected with the coupling portion 20, and is disposed on the grounding portion 30. The adjusting portion 40 has a structure that rotates to drive the coupling portion 20 (e.g., a pivot seat), so as to adjust the angle formed between the coupling portion 20 and the metal circuit portion 10. The adjusting portion 40 can also be disposed on the case of the adjustable phase shifter, the metal circuit portion 10, or other objects capable of providing a fixed point of support. The adjusting portion 40 can also use other displacement technical means to achieve the pivot structure capable of adjusting the angle formed between the coupling portion 20 and the metal circuit portion 10, e.g., a pivot structure with two rotation axes (X axis and Y axis).

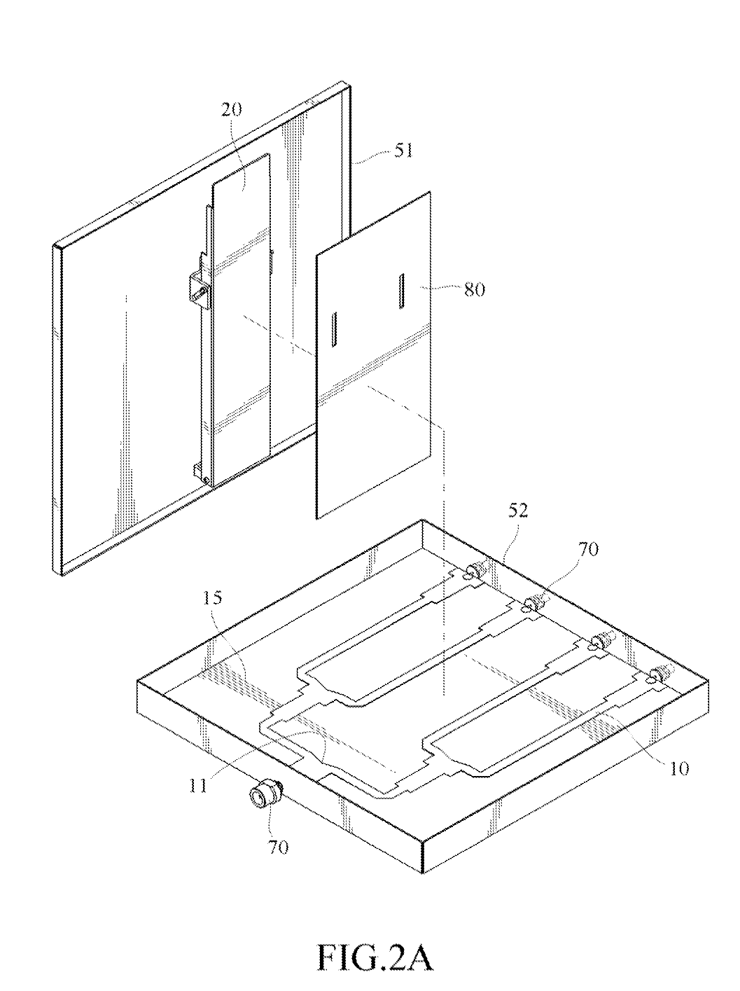

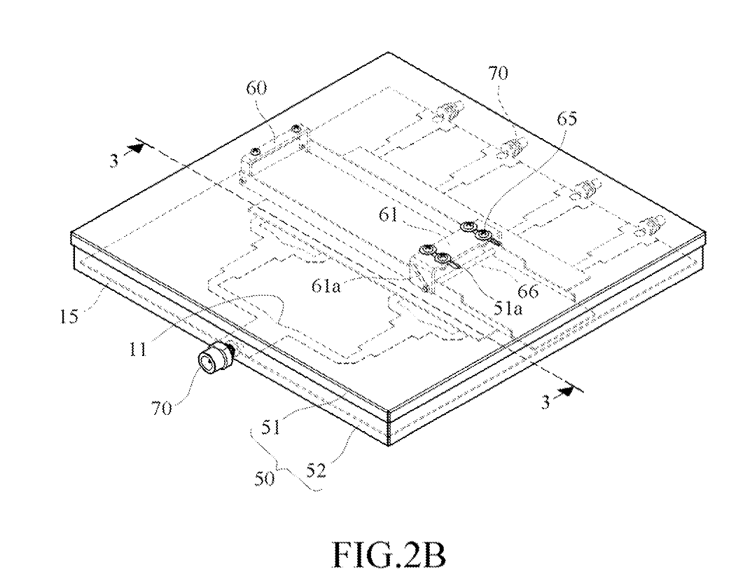

Referring to FIGS. 2A and 2B, an adjustable phase shifter for an antenna of a fifth embodiment is shown. As shown in FIG. 2A, the adjustable phase shifter for an antenna includes a metal circuit portion 10, a coupling portion 20, a case 50, a first fixing member 60, a second fixing member 61, signal connection terminals 70, and an impedance matcher 80. The case 50 is formed by combining a first case 51 with a second case 52.

The metal circuit portion 10 is formed on a printed circuit board 15 (PCB 15), and is disposed in the second case 52 for transmitting signals. The metal circuit portion 10 further includes a power distributor 11 for distributing transmission power of a signal to the signal transmission lines.

The coupling portion 20 is a plate structure made of a metal and is rectangular-shaped. The coupling portion 20 is disposed in the first case 51 through the first fixing member 60 and the second fixing member 61, for controlling the phase angle of the signal after passing through the metal circuit portion 10.

The first case 51 has two first slots 51a in parallel to each other (as shown in FIG. 2B), and the direction of the first slots 51a is approximately the same as the direction of a longitudinal axis of the coupling portion 20. A plurality of signal connection terminals 70 is disposed on both sides of the second case 51, and signal contacts (not shown) in the signal connection terminals 70 are electrically coupled to the metal circuit portion 10. The second case 52 can be used as a grounding portion of the adjustable phase shifter for an antenna.

One end of the first fixing member 60 is fixed on the first case 51, and the other end of the first fixing member 60 is pivoted to the end of the coupling portion 20. One end of the second fixing member 61 is fixed to the movable portion 65, and the movable portion 65 is disposed in the first slots 51a of the first case 51. The movable portion 65 can slide in the first slots 51a, such that the second fixing member 61 is movably disposed in the first case 51. The second fixing member has two second slots 61a formed on both sides of the other end of the second fixing member 61, and the direction of the second slot 61a is at an angle, e.g., 45 degrees, with respect to the first slots 51a of the first case 50. A sliding pin 66 is fixed to the coupling portion 20 and inserted into the second slot 61a of the second fixing member 61. The sliding pin 66 can slide in the second slot 61a, such that the coupling portion 20 is beveled and forms an angle with respect to the metal circuit portion 10.

The impedance matcher 80 is used for shielding light, and is attached on the surface of the coupling portion 20 for matching the circuit impedance of the metal circuit portion 10. The length of a short axis of the impedance matcher 80 is slightly larger than the length of a short axis of the coupling portion 20, and the coupling portion 20 is rectangular-shaped trapezoidal-shaped. By designing the area of the impedance matcher 80 and the number of attached layers, the impedance value of the impedance matcher 80 can be adjusted to match the circuit impedance of the metal circuit portion 10. The impedance matcher 80, for example, can be a heat insulation film for automobiles.

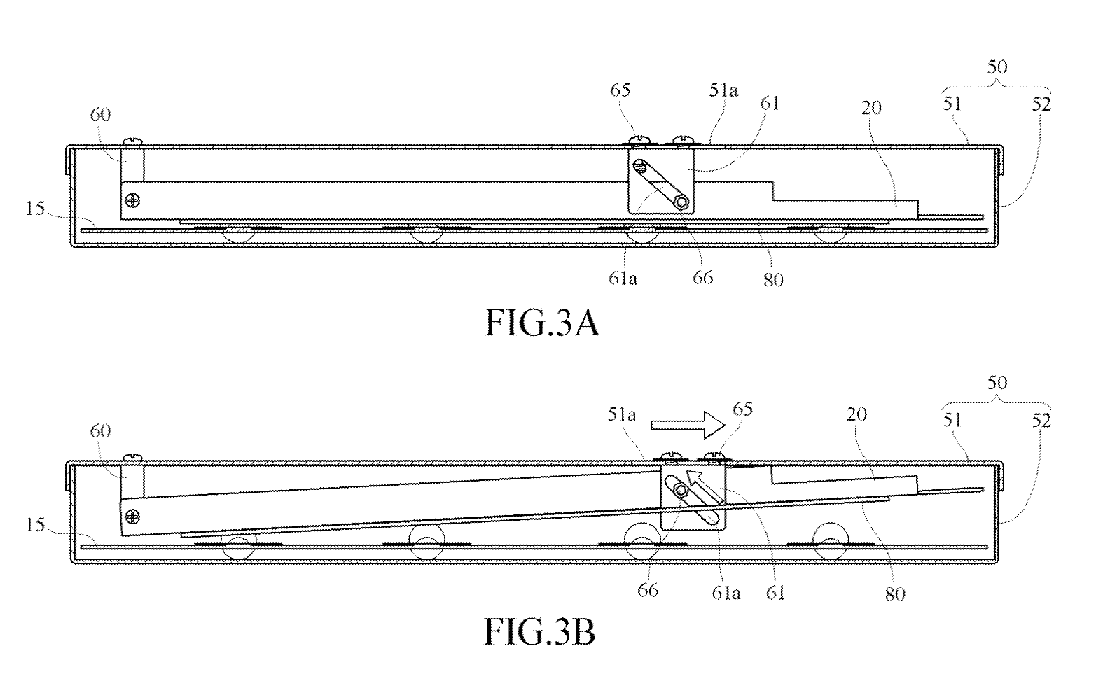

Referring to FIGS. 3A and 3B, the operation of the adjustable phase shifter for an antenna is described.

When the movable portion 65 is moved from a first position to a second position in the notches 51a, the second fixing member 61 is driven to move from the first position to the second position by the movable portion 65.

When the second fixing member 61 moves from the first position to the second position, the sliding pin 66 in the second slot 61a is moved from the original first position to the second position (as shown in FIG. 3B).

Meanwhile, the sliding pin 66 drives the coupling portion 20 to move from the first position to the second position. That is, after the movable portion 65 is moved, the coupling portion 20 originally in parallel to the metal circuit portion 10 on the PCB 15 will be beveled, and form an angle with respect to the metal circuit portion 10 on the PCB 15.

Therefore, when a signal is transmitted through the metal circuit portion 10, as the vertical distances between the coupling portion 20 and the signal transmission lines on the metal circuit portion 10 are different, the coupling amounts of the signal on the signal transmission lines are also different (for example, as the vertical distances between the coupling portion 20 and the signal transmission lines on the metal circuit portion 10 are different, the coupling amounts of the signal on the signal transmission lines will increase or decrease). Thus, the phase shift amount of the signal when passing through the signal transmission lines is changed to control the phase angle of the signal.

To sum up, the adjustable phase shifter for an antenna in the present invention adjusts the angle formed between the coupling portion and the phase shifter, such that the coupling amounts of different output ends of the phase shifter are different, thereby strengthening the control over the change of the phase angle of each output end. Moreover, the adjustable phase shifter for an antenna adopts the attachable impedance matcher, or changes the shape and structure of the coupling portion, so as to improve the convenience in fabricating the phase shifter.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An adjustable phase shifter for an antenna, comprising:
a metal circuit portion, for receiving a fed-in signal;
a coupling portion, disposed on one side of the metal circuit portion, and disposed at an angle with respect to the metal circuit portion, for controlling a phase angle of the fed-in signal by adjusting the angle formed between the coupling portion and the metal circuit portion; and
a grounding portion, disposed on the other side of the metal circuit portion in parallel.

2. The adjustable phase shifter for an antenna as claimed in claim 1, further comprising an adjusting portion connected with the coupling portion for adjusting the angle formed between the coupling portion and the metal circuit portion.

3. The adjustable phase shifter for an antenna as claimed in claim 2, wherein the adjusting portion is disposed on the grounding portion.

4. The adjustable phase shifter for an antenna as claimed in claim 1, wherein the cross-section area of the coupling portion is U-shaped.

5. The adjustable phase shifter for an antenna as claimed in claim 1, wherein the coupling portion is made of a dielectric material.

6. The adjustable phase shifter for an antenna as claimed in claim 1, wherein two parallel sides of the coupling portion are jagged.

7. The adjustable phase shifter for an antenna as claimed in claim 1, wherein the metal circuit portion has a signal input end for receiving fed-in signal, at least one signal output end for outputting the fed-in signal, and least one signal transmission line for transmitting the fed-in signal from the signal input end to the signal output end.

8. The adjustable phase shifter for an antenna as claimed in claim 7, wherein the signal transmission lines have a plurality of metal wires.

9. The adjustable phase shifter for an antenna as claimed in claim 7, wherein the signal transmission lines are straight lines.

10. The adjustable phase shifter for an antenna as claimed in claim 7, wherein the signal transmission lines are serpentine lines.

11. The adjustable phase shifter for an antenna as claimed in claim 7, wherein the signal transmission lines are zigzag lines.

12. The adjustable phase shifter for an antenna as claimed in claim 7, wherein the signal transmission lines are arranged in parallel to one another.

13. The adjustable phase shifter for an antenna as claimed in claim 1, further comprising:
a case having at least one first slot, for the coupling portion and the metal circuit portion being disposed therein;
a first fixing member, fixed on the case and pivoted to the coupling portion;
a movable portion, disposed in the first slot;
a second fixing member, fixed to the movable portion and having at least one second slot; and
a sliding pin, fixed to the coupling portion and inserted into the second slot of the second fixing member;
wherein the movable portion drives the second fixing member to move by adjusting a position of the movable portion in the first slot, when the second fixing member moves, the sliding pin drives the coupling portion and the metal circuit portion to change the angle formed therebetween.

14. The adjustable phase shifter for an antenna as claimed in claim 13, wherein the case further comprises:
a first case, for the coupling portion being disposed therein; and
a second case, for the metal circuit portion being disposed therein.

15. The adjustable phase shifter for an antenna as claimed in claim 13, further comprising an impedance matcher attached on a surface of the coupling portion, for matching a circuit impedance of the metal circuit portion.

16. The adjustable phase shifter for an antenna as claimed in claim 15, wherein the impedance matcher is rectangular-shaped.

17. The adjustable phase shifter for an antenna as claimed in claim 15, wherein the impedance matcher is trapezoidal-shaped.
